(19) United States
(12) Patent Application Publication
(10) Pub. No.: US 2002/0171519 A1
(43) Pub. Date: Nov. 21, 2002

(54) Clapper-type electromagnet assembly having v-shaped air gap for use in a circuit breaker trip unit

(75) Inventors: Scott Lanning, Greensboro, NC (US); Calvin L. Oetjen, Rushsylvania, OH (US)

Correspondence Address: Siemens Corporation, Intellectual Property Department, 186 Wood Avenue South, Iselin, NJ, 08830, US

(73) Assignee: Siemens Energy & Automation, Inc.

(21) Appl. No.: 09/859,860

(22) Filed: May 17, 2001

(51) Int. Cl. H01H 9/00

(52) U.S. Cl. 335/172

(57) ABSTRACT

An electromagnet assembly 200 for a circuit breaker trip unit includes a yoke 222, an armature 218 mounted for movement with respect to the yoke, and a coil 224, mounted with respect to the yoke for generating a magnetic field when energized with electrical current. The yoke and armature have complimentary male and female edges defining a working air gap C therebetween. When the coil 224 is energized, the magnetic field pulls the armature 218 towards the yoke 222 at a beginning of a stroke of the armature reducing the working air gap until the armature is seated at the yoke at an end of the stroke of the armature.

### FIELD OF THE INVENTION

The invention generally relates to electromagnet assemblies and, more particularly, to clapper-type electromagnet assemblies for use in circuit breaker trip units which are designed to trip upon the occurrence of a short circuit.

### BACKGROUND OF THE INVENTION

Molded case circuit breakers sense and trip (open to interrupt current flow in the circuit) in several ways to provide different types of circuit protection. This invention relates to circuit breaker tripping during short circuits. When two bare conductors in the circuit touch, a short circuit occurs. The resistance drops to almost zero and the current can be thousands of times higher than normal operating current. This circuit condition can cause extensive damage to conductors and equipment and must be interrupted instantly.

With reference to FIG. 1, the circuit breaker component that accomplishes the sensing and tripping is the conventional trip unit, generally indicated at 10. The trip unit 10 includes a tripper bar 12 or lever that unlatches a mechanism 14 and allows a contact 16 to open. The tripper bar 12 is moved by an armature 18 of an electromagnet short circuit sensing assembly, generally indicated at 20. As shown in FIG. 2, the conventional electromagnet assembly 20 consists of a yoke 22, a coil 24 and the armature 18. The electromagnet assembly 20 converts electrical energy into force and motion. When the coil 24 is energized with electric current from a short circuit, an electromagnetic force is created around the coil 24. The magnetic force is directed though the steel yoke 22 and armature 18 such that the yoke 22 becomes a north or south facing pole depending on the polarity of the coil 24. The armature 18 becomes the opposite pole face. These opposite pole faces are attracted to one another and this creates the force and motion of the armature 18. The amount of force created is related to the amount of electrical current applied, and the electromagnet assembly 20 is designed to only create enough force and motion to trip under high currents of a short circuit. Other factors such as the number of turns of wire in the coil and the magnetic characteristics of steel used also affects the amount of force developed by the electromagnet assembly 20.

The force on the armature 18 is also dependent on the air gap of the electromagnet assembly 20, in particular, the air gap 26 between the armature 18 and yoke 22 (FIG. 3). The force is lowest at a maximum air gap and highest when the pole faces are fully seated. In general, the force is inversely proportional to the square of the distance (working air gap) between the pole faces. The geometry of the yoke 22 and armature 18 together determine the force/stroke characteristics of the electromagnet assembly 20 when current passes through the coil 24. The magnetic field created pulls the armature into the yoke until the armature seats against the yoke. The armature seats only when the load on the armature is less than the force the assembly 20 generates throughout its stroke. Generally, force increases throughout the stroke range, typically exerting the least amount of force at the beginning (open) of the stroke and the highest amount of force at the end (closed) of the stroke. In conventional electromagnet assemblies, straight armature and yoke edges 28 and 30 are used which generate short strokes of high holding force. However, short strokes and high holding force are not required in a electromagnet assembly for use in a circuit breaker trip unit.

There is a need to provide an electromagnet assembly for use in an circuit breaker trip unit which ensures an increase in pull-in force at the beginning of a stroke of the armature, without reducing the stroke.

### SUMMARY OF THE INVENTION

An object of the invention is to fulfill the need referred to above. In accordance with the principles of the present invention, this objective is achieved by providing an electromagnet assembly for a circuit breaker trip unit includes a yoke, an armature mounted for movement with respect to the yoke, and a coil mounted with respect to the yoke for generating a magnetic field when energized with electrical current. The yoke and armature have complimentary male and female edges defining a working air gap therebetween. When the coil is energized, the magnetic field pulls the armature towards the yoke at a beginning of a stroke of the armature reducing the working air gap until the armature is seated at the yoke at an end of the stroke of the armature. The working air gap is generally V-shaped and provides higher forces at the beginning of the stroke as compared to a conventional straight working air gap.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic illustration of a conventional circuit breaker trip unit.

FIG. 2 is a perspective view of an electromagnet assembly of the trip unit of FIG. 1.

FIG. 3 is a view of a working air gap between the yoke and armature of the electromagnet assembly of FIG. 2.

FIG. 4 is a perspective view of an electromagnet assembly of a circuit breaker trip unit provided in accordance with the principles of the present invention.

FIG. 5 is a view of a working air gap and stroke between the yoke and armature of the electromagnet assembly of FIG. 4.

### DETAILED DESCRIPTION OF THE PREFERRED EMBODIMENT

The invention relates to clapper-type electromagnet assemblies used in circuit breaker trip units of the type described above with reference to FIG. 1. With reference to FIG. 4, a clapper-type electromagnet assembly, provided in accordance with the principles of the invention, is shown generally indicated at 200. The electromagnet assembly 200 is similar to the conventional assembly 20 of FIG. 1 in that it consists of a steel yoke 222, a coil 224 mounted with respect to the yoke 222 and an armature 218 mounted for movement with respect to the yoke 222. The electromagnet assembly 200 is constructed and arranged to control a tripper bar 12, in the manner discussed above with regard to FIG. 1, to unlatch a mechanism 14 and allow a contact 16 to open.

In accordance with the invention, the armature 218 and yoke 222 have complimentary male and female edges defining a working air gap C therebetween. In the illustrated embodiment, as shown in FIGS. 4 and 5, the armature has surfaces 228 and 230 which join at an apex 232 to form a generally V-shaped male edge. In FIG. 5, angle A between the surfaces 228 and 230 is about 100 degrees, but can be of any degrees. The yoke 222 has surfaces 234 and 236 which correspond respectively with surfaces 228 and 230 of the armature 218 to form a generally V-shaped female edge. The female edge receives the male edge of the armature 218 when the coil is energized and the magnetic field generated thereby causes the armature to move thus reducing the air gap C until the armature 218 is seated at the yoke 222. As shown in FIG. 5, the working air gap C is less than the maximum stroke distance.

Although the male edge is shown to be part of the armature 218 and the female edge is part of the yoke, it can be appreciated that the yoke 222 can include the male edge and the armature 218 include the female edge. Furthermore, the male and female edges may be of other shapes, such as U-shaped, etc.

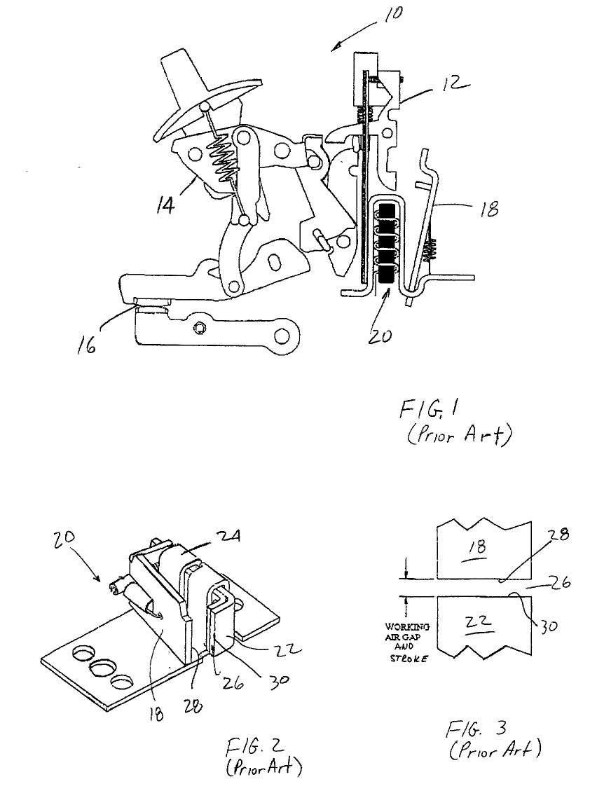

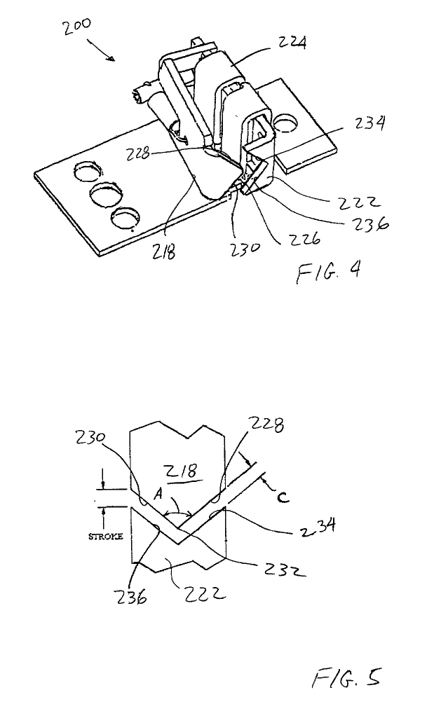

The V-shaped edges of the armature 218 and yoke 222 provide more pull-in force on the armature 218, particularly at the at the beginning of the armature stroke, than the conventional straight edge armature and yoke. This is due to the geometry of the gap, reducing the working air gap C while maintaining the same stroke as the conventional electromagnet assembly (FIG. 3). It is important to maintain the stroke since if the stroke were decreased with the air gap being decreased, the available momentum would also decrease. Thus, there would be less energy available to trip, countering the advantages obtained from the shorter air gap. When the electromagnet assembly 200 is employed in a circuit breaker trip unit, the higher pull-in force due to the V-shaped geometry of the yoke and armature edges permits the breaker to trip and provide circuit protection at lower short circuit current levels than the electromagnet assembly of FIG. 2 having a yoke and armature with complimentary straight edges. The V-shaped armature and yoke also improves the performance of the electromagnet assembly without increasing cost or requiring a change in the fabrication and assembly process.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An electromagnet assembly for a circuit breaker trip unit comprising:
a yoke;
an armature mounted for movement with respect to the yoke; and
a coil mounted with respect to the yoke for generating a magnetic field when energized with electrical current,
wherein the yoke and armature have complimentary male and female edges defining a working air gap therebetween, and when the coil is energized, the magnetic field pulls the armature towards the yoke at a beginning of a stroke of the armature reducing the working air gap until the armature is seated at the yoke at an end of the stroke of the armature.

2. The electromagnet assembly of claim 1, wherein the male edge is of generally V-shaped configuration and the female edge is of a configuration complimentary to the V-shaped configuration so as to receive the male edge.

3. The electromagnet assembly of claim 1, wherein the male and female edges are constructed and arranged such that the working air gap distance is less than the maximum stroke distance.

4. The electromagnet assembly of claim 2, wherein the generally V-shaped male edge comprises two surfaces joined at an apex.

5. An electromagnet assembly for a circuit breaker trip unit comprising:
a yoke having a generally V-shaped female edge portion;
an armature mounted for movement with respect to the yoke, the armature having generally V-shaped male edge portion which compliments the V-shaped female edge portion of the yoke such that the male edge portion of the armature can be received in the female edge portion of the yoke, and
a coil mounted with respect to the yoke for generating a magnetic field when energized with electrical current,
wherein, the male and female edge portions define a working air gap and, when the coil is energized, the magnetic field pulls the armature towards the yoke at a beginning of a stroke of the armature reducing the working air gap until the armature is seated at the yoke at an end of the stroke of the armature.

6. The electromagnet assembly of claim 5, wherein the male and female edges are constructed and arranged such that the working air gap distance is less than the maximum stroke distance.

7. The electromagnet assembly of claim 5, wherein the generally V-shaped male edge comprises two surfaces joined at an apex.

8. In a circuit breaker trip unit having a clapper-type electromagnet assembly for moving a tripper bar such that the tripper bar unlatches a mechanism permitting an electrical contact to open, the electromagnet assembly comprising:
a yoke;
an armature mounted for movement with respect to the yoke; and
a coil mounted with respect to the yoke for generating a magnetic field when energized with electrical current,
wherein the yoke and armature have complimentary male and female edges defining a working air gap therebetween, and when the coil is energized, the magnetic field pulls the armature towards the yoke at a beginning of a stroke of the armature reducing the working air gap until the armature is seated at the yoke at an end of the stroke of the armature.

9. The electromagnet assembly of claim 8, wherein the male edge is of generally V-shaped configuration and the female edge is of a configuration complimentary to the V-shaped configuration so as to receive the male edge.

10. The electromagnet assembly of claim 8, wherein the male and female edges are constructed and arranged such that the working air gap distance is less than the maximum stroke distance.

11. The electromagnet assembly of claim 9, wherein the generally V-shaped male edge comprises two surfaces joined at an apex.
